(19) United States
(12) Patent Application Publication
(10) Pub. No.: US 2019/0042942 A1
(43) Pub. Date: Feb. 7, 2019

(54) HYBRID SPIKING NEURAL NETWORK AND SUPPORT VECTOR MACHINE CLASSIFIER

(71) Applicant: Koba Natroshvili, Wadlbronn (DE)

(72) Inventor: Koba Natroshvili, Wadlbronn (DE)

(21) Appl. No.: 15/834,917

(22) Filed: Dec. 7, 2017

(51) Int. Cl. G06N 3/08; G06N 3/04

(52) U.S. Cl. CPC G06N 3/082; G06N 99/005; G06N 3/049

(57) ABSTRACT

System and techniques for a spiking neural network and support vector machine hybrid classifier are described herein. A first set of sensor data may be obtained, e.g., from a corpus of sample sensor data. A feature set is extracted from the sensor data using a spiking neural network (SNN). A support vector machine (SVM) may then be created for the sensor data using the feature set. The SVM may then be used to classify a second set of sensor data.

### TECHNICAL FIELD

Embodiments described herein generally relate to artificial intelligence and more specifically to a hybrid spiking neural network and support vector machine classifier.

### BACKGROUND

Artificial intelligence is a field concerned with developing artificial systems to perform cognitive tasks that have traditionally required a living actor, such as a person. Artificial neural networks (ANNs) have proven to be a useful tool in achieving tasks that have heretofore been accomplished by people. There are many different ANN designs, including spiking neural networks (SNN). An SNN differs from other ANNs in its use of time of activation (e.g., when a spike arrives) at a neuron as well as connectivity of the activation (e.g., from what neuron was the spike sent and to which synapse was the spike received).

Support vector machines (SVMs) are another device used in AI. SVMs operate by building a model of training examples—each of which is marked as belonging to one or the other of two classes (e.g., categories)—that assigns new examples (e.g., new data) to one category or the other. Generally, the SVM model represents examples as points in space. Examples in a given category are mapped into the space such that they cluster together, and are divided by a gap from a cluster of examples from another category. New examples are then mapped into that same space and predicted to belong to a category based on which side of the gap they fall.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for a hybrid spiking neural network and support vector machine classifier, according to an embodiment.

FIG. 2 is a diagram of an example of a neural network, according to an embodiment.

FIG. 3 illustrates spiking in a neural network pathway to implement spike timing dependent plasticity (STDP), according to an embodiment.

FIG. 4 illustrates an example of STDP that results in synapse weighting, according to an embodiment.

FIG. 5 illustrates an example of values from unsupervised STDP learning, according to an embodiment.

FIG. 6 illustrates an example of SNN learning a pattern via STDP, according to an embodiment.

FIGS. 7A-7D illustrate an example of synapse weight progression during SNN learning via STDP, according to an embodiment.

FIG. 8 illustrates an example of a SNN to implement multi-part pattern detection, according to an embodiment.

FIG. 9 illustrates encoding an image into a feature-set using an SNN, according to an embodiment.

FIG. 10 illustrates a pipeline to create a reduced set SVM, according to an embodiment.

FIG. 11 illustrates a pipeline to create a reduced set SVM, according to an embodiment.

FIG. 12 illustrates a flow diagram of an example of a method for a hybrid spiking neural network and support vector machine classifier, according to an embodiment.

FIG. 13 is a block diagram illustrating an example of a machine upon which one or more embodiments may be implemented.

### DETAILED DESCRIPTION

An issue present with SVM use includes preparing training data for the SVM. Because the SVM uses classified (e.g., categorized) features mapped into a space, it is necessary to label each feature in order to determine a hyperplane that divide features from one class and another. Generally, this categorization of training data must be done by a person, greatly increasing the cost of creating robust training sets and thus the cost of creating effective SVMs. To address these issues, an SNN is used to categorize features in an unsupervised manner.

SNNs provide a more realistic model of biological neural networks than other ANNs by incorporating the timing of spikes as well as the connections between neurons. The additional complexity of accounting for spike timing may be avoided on traditional platforms (e.g., von Neumann architectures), but may be easier to use on new computing models, such as neuromorphic cores, chips, or chip clusters. The techniques described below, however, will operate without regard to any particular computing architecture.

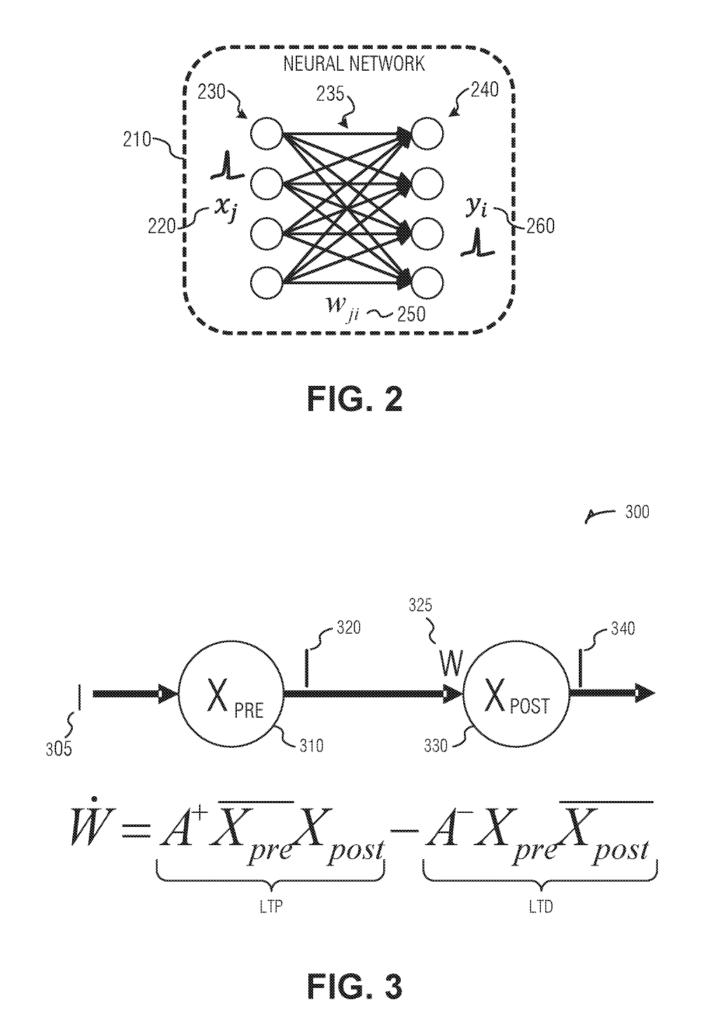

SNN architecture permits a relatively powerful implementation of Hebbian learning in STDP. STDP essentially enforces connections to a neuron that provided spikes that preceded that neuron's own spike and dampens connections to the neuron that provided spikes that follow the neuron's own spike. Additional details of the operation of STDP in an SNN are provided below with respect to FIGS. 2-8. The operation of STDP in SNNs provides an unsupervised training of the SNN to recognize simple (e.g., non-multi-part) patterns.

Because SNNs operate on a temporal spiking model, input to the SNN is timed spikes. This allows relatively straightforward application to pattern recognition of, for example, audio data, or in imaging devices such as a Dynamic Vision Sensor (DVS) camera, which is not frame based, but rather sends a message for each pixel when that pixel changes (e.g., either greater or lesser luminance) from a previous condition. There is not, however, a straightforward application to static spatial images, which are unchanging images defining pixels over an area as would typically be the case of raster images or encodings that produce raster images such as JPEG, PNG, or GIF encodings.

The feature set produce by the SNN is then used to create the SVM feature vectors. Thus, a collection of unlabeled samples may be submitted to the hybrid SNN and SVM creation apparatus to create a performant SVM. In an example, the SVM may be made more performant by replacing the traditional support vectors with reduced set vectors, in which eigenvectors corresponding to the support vectors are used. Additional details and examples are described below.

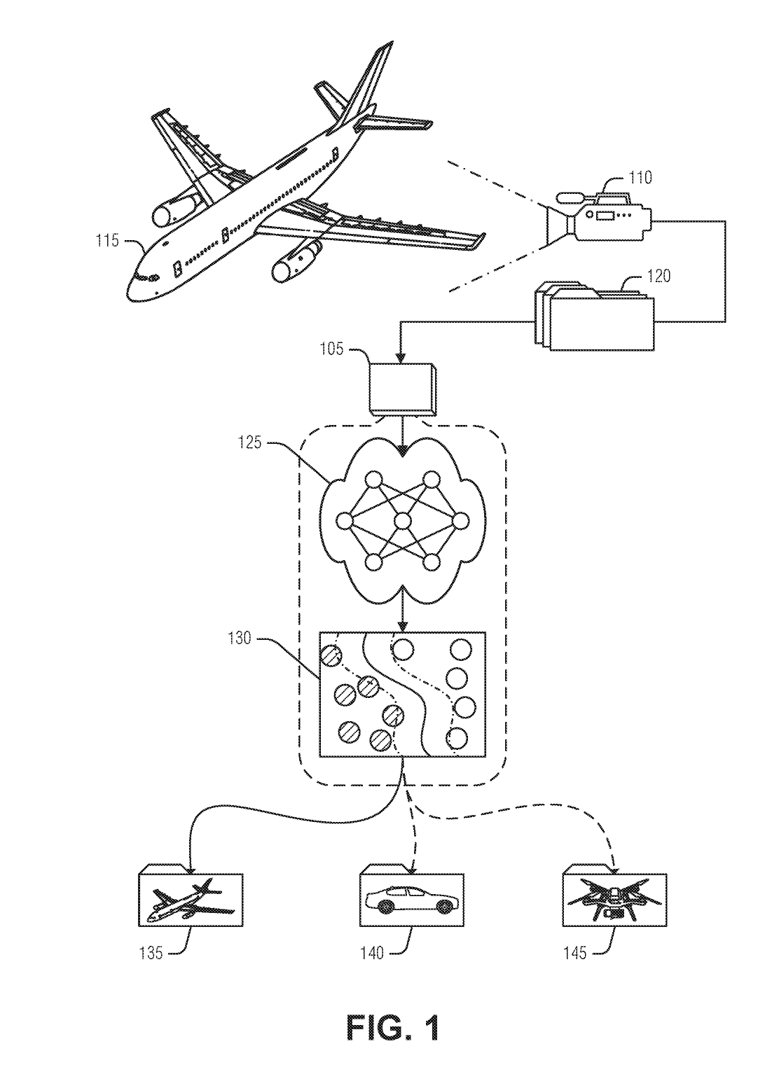

FIG. 1 is a block diagram of an example of an environment including a system for a hybrid spiking neural network and support vector machine classifier, according to an embodiment. The system may include a sensor (e.g., camera 110) and computing hardware 105. The computing hardware 105 may include processing circuitry, neuro-cores, graphics processing units, etc. to implement a SNN 125 and a SVM 130.

The computing hardware 105 is arranged to obtain (e.g., retrieve or receive) a first set of sensor data 120. Here, the sensor data is a representation of an object, such as the aircraft 115, that will be classified by the SVM 130. In an example, the first set of sensor data 120 is encoded as a frequency of spikes. This is useful when providing the sensor data 120 to the SNN 125. In an example, the sensor data 120 is an image encoded in pixels with a luminance value. Thus, the representation of the aircraft 115 in this example, is the image captured by the camera 110. In an example, the frequency of spikes is inversely related to the luminance value. In an example, a luminance value equivalent to black has a frequency often hertz, and a luminance value equivalent to white has a frequency of ninety hertz. For color images, each color channel may be treated as a luminance value. Thus, a “black” pixel in the blue color channel is a completely blue pixel. Here, the spike frequency may be similar across different colors. Differentiating between colors may be accomplished by designating certain inputs to the SNN as belonging to a given color. In an example, a chrominance value may be used instead of the luminance value with a spectrum of spiking frequency to designate the colors.

The computing hardware 105 is arranged to extract a feature set from the sensor data 120 using the SNN 125. In an example, the feature set is a frequency of spikes from output neurons of the SNN. In an example, neurons in a pattern recognition layer of the SNN include inhibitory paths to all other neurons of the pattern recognition layer. Additional details with regard to the automatic pattern recognition in a data set are provided below with respect to FIGS. 2-8.

The computing hardware 105 is arranged to create the SVM 130 for the sensor data 120 using the feature set. Here, the feature set provides the classification (e.g., categorization) of the sensor data 120 that allows a hyperplane to be devised to separate features from different classes. In an example, the SVM 130 is a reduced set vector SVM. A reduced set SVM uses eigenvectors, derived from support vectors, in place of the support vectors. The advantage is a reduction in a number of features to test to classify new data. That is, in a traditional SVM, support vectors provide boundaries for class features. Features of new data is mapping into the SVM feature space and compared to the boundary features. A reduced set SVM replaces the support vectors with eigenvectors that have fewer points to define the same feature boundary. Thus, classification using a reduced set SVM is more efficient.

In an example, the SVM 130 is a multiclass SVM. A multiclass SVM distinguishes between more than two classes. Generally, this entails multiple hyperplanes, at least one to distinguish between features of each class. For example, one class may identify gender (e.g., a hyperplane to divide male features from female features) and a second class may identify hair color (e.g., a hyperplane to divide black hair from brown hair). When a new sample is being classified, its features are plotted into the SVM space and their position vis-à-vis the multiple hyperplanes will determine the classification. In an example, creating the SVM 130 includes creating SVM solutions for binary classifications of a set of possible classifications. Here, a binary classification is one that separates input into one of two classes (e.g., male or female, not both and not another class). In an example, at least one technique of one-against-one or one-against-all is used for the binary classifications. This means that, when integrating two binary classifications together, the hyperplanes may be created based on one of these two techniques. In one-against-one, a classification is compared against all other classifications, one at a time, creating hyperplanes between all. Thus, brown hair is distinguished from each of black hair, male, and female. In one-against-all, brown hair is distinguished from all other classes by a single hyperplane. Thus, here, only the features unique to brown hair will be considered, whereas in one-against-one, brown hair features may be combined with male features and female features when compared to black hair. The SVM 130 is illustrated as a multiclass SVM, having possible classifications of aircraft 135, automobile 140, or flying drone 145.

In an example, when creating the SVM 130 the computing hardware 105 reduces each SVM solution for the binary classes. In an example, reducing an SVM solution includes performing eigenvalue decomposition on support vectors for each SVM solution to find eigenvectors to replace the support vectors. More details are given below, however, the technique involves establishing an equivalent set of feature boundary points even though these points may never have been in the original training data set. The reduction in these boundary defining points reduces classification times for the SVM 130. The replacement of traditional support vectors by eigenvectors distinguishes the reduced set SVM from a traditional SVM.

In an example, to create the SVM 130, the computing hardware 105 is arranged to combine reduced set vectors for all SVM solutions for binary classifications into a single joint list. All binary SVM solutions may then be retrained using the joint list. In an example, original support vectors (e.g., the support vectors used to derive the eigenvectors) for each SVM solution for binary classifications are also included in the joint list. In an example, one of several kernels is used in the retraining. Here, although different kernels may have been used for any given binary classification, a single kernel is used in the retraining. This contrasts with another example in which multiple kernels are used in the retraining.

In an example, to combine the reduced set vectors, the computing hardware 105 is arranged to prune vectors from the joint list. In an example, pruning the vectors includes at least one of reducing a vector size or eliminating a vector with a low weighting factor. This further reduction in the number of feature boundary defining vectors again speeds classification over an unpruned set of vectors.

In an example, the vector pruning iterates until a performance metric is reached. Thus, the pruning may start conservatively and continue to remove vectors until a threshold corresponding to classification performance is met. In an example, the performance metric is ratio of detection to false positive. In an example, the performance metric is a time-to-classification measure. In these examples, the vector list is minimized while meeting a minimum standard for detection (e.g., correctly classifying a sample) or time to produce a classification.

The computing hardware 105 is arranged to classify a second set of sensor data using the SVM 130. Thus, once the SVM 130 is created (e.g., trained) on the first sensor data 120, the SVM 130 may be used to perform classifications. Additional details and examples of SNNs and reduced set SVMs are described below.

FIG. 2 is a diagram of an example of a neural network 210, according to an embodiment. The neural network 210 includes connections 235 between a first set of nodes 230 (e.g., input neurons) and a second set of nodes 240 (e.g., output neurons). Neural networks (such as the neural network 210) are commonly organized into multiple layers, including input layers and output layers. Thus, the neural network 210 may be modeled as a graph in which nodes of the graph represent neurons and connections in the graph represent connections between those neurons. Here, the neural network 210 only depicts two layers and a small number of nodes but other forms of neural networks may include a large number of nodes, layers, connections, and pathways.

Data that is provided into the neutral network is first processed by synapses of input neurons. Interactions between the inputs, the neuron's synapses and the neuron itself govern whether an output is provided via an axon to another neuron's synapse. Modeling the synapses, neurons, axons, etc., may be accomplished in a variety of ways. In an example, neuromorphic hardware includes individual processing elements in a synthetic neuron (e.g., neurocore, neural-core, neural processor, etc.) and a messaging fabricate to communicate outputs to other neurons. Neuromorphic hardware thus includes electronic elements that more closely model the biological neuron to implement the neural network. The techniques described herein will operate on a variety of neuromorphic hardware implementations, as well as software modeled networks such as may be executed a van Neumann architecture or other computing architecture.

The determination of whether a particular neuron “fires” to provide data to a further connected neuron is dependent on the activation function applied by the neuron and the weight of the synaptic connection (e.g., wⱼᵢ 250) from neuron j (e.g., located in a layer of the first set of nodes 230) to neuron i (e.g., located in a layer of the second set of nodes 240). The input received by neuron j is depicted as value xⱼ 220, and the output produced from neuron i is depicted as value yᵢ 260. Thus, the processing conducted in the neural network 210 is based on weighted connections, thresholds, and evaluations performed among the neurons, synapses, and other elements of the neural network.

In an example, the neural network 210 is implemented in a network of spiking neural network cores, with the neural network cores communicating via short packetized spike messages sent from core to core. For example, each neural network core may implement some number of primitive nonlinear temporal computing elements as neurons, so that when a neuron's activation exceeds some threshold level, it generates a spike message that is propagated to a fixed set of fan-out neurons contained in destination cores. The network may distribute the spike messages to all destination neurons, and in response those neurons update their activations in a transient, time-dependent manner, similar to the operation of real biological neurons.

FIG. 2 further shows the receipt of a spike, represented in the value xⱼ 220, at neuron j in a first set of neurons (e.g., a neuron of the first set of nodes 230). The output of the neural network 210 is also shown as a spike, represented by the value yᵢ 260, which arrives at neuron i in a second set of neurons (e.g., a neuron of the second set of nodes 240) via a path established by the connections 235. As noted above, in an SNN, communication occurs over event-driven action potentials, or spikes. In an example, the spikes convey no information other than the spike time as well as a source and destination neuron, or synapse, pair. Computation occurs in each neuron as a result of the dynamic, nonlinear integration of weighted spike input using real-valued state variables. The temporal sequence of spikes generated by or for a particular neuron may be referred to as its “spike train.”

FIG. 3 illustrates spiking in a neural network pathway 300 to implement STDP, according to an embodiment. As shown, the pathway 300 includes one or more inputs 305 (e.g., a spike or spike train) being provided to a neuron X_{PRE} 310 for processing. The neuron X_{PRE} 310 causes a first spike 320, which is propagated to a neuron X_{POST} 330 for processing. The connection between the neuron X_{PRE} 310 and the neuron X_{POST} 330 (e.g., a synaptic connection) is weighted based on a weight W 325. If inputs received at neuron X_{POST} 330 (e.g., received from one or multiple connections) reach a particular threshold, the neuron X_{POST} 330 will activate (e.g., “fire”), causing a second spike 340 to be sent (e.g., to other, downstream neurons). The determination that the second spike 340 is caused as a result of the first spike 320 is used to strengthen the connection between the neuron X_{PRE} 310 and the neuron X_{POST} 330 (e.g., by modifying the weight W 325) based on principles of STDP.

Specifically, STDP is used to adjust the strength of the connections (e.g., synapses) between neurons in a neural network by correlating the timing between an input spike (e.g., the first spike 320) and an output spike (e.g., the second spike 340). Input spikes that closely (e.g., as defined by a configuration parameter such as ten milliseconds or a function) precede an output spike for a neuron are considered causal to the output and are strengthened, while other input spikes may be weakened. For example, the adjusted weight produced from STDP in this example may be represented by the following (replicated in FIG. 3):

\dot{W}=A⁺X̅ₚ̅ᵣ̅ₑ̅−A⁻XₚᵣₑX̅ₚ̅ₒ̅ₛ̅ₜ̅

where A⁺X̅ₚ̅ᵣ̅ₑ̅Xₚₒₛₜ represents long term potentiation (LTP) and A⁻XₚᵣₑX̅ₚ̅ₒ̅ₛ̅ₜ̅ represents long term depression (LTD) of a particular synapse weight.

The illustrated neural network pathway 300, when combined with other neurons operating on the same principles, exhibit a natural unsupervised learning as repeated patterns in the inputs 305 will have their pathways strengthened over time. Conversely, noise, which may produce the spike 320 on occasion, will not be regular enough to have associated pathways strengthened. Generally, the original weightings of any connections are random.

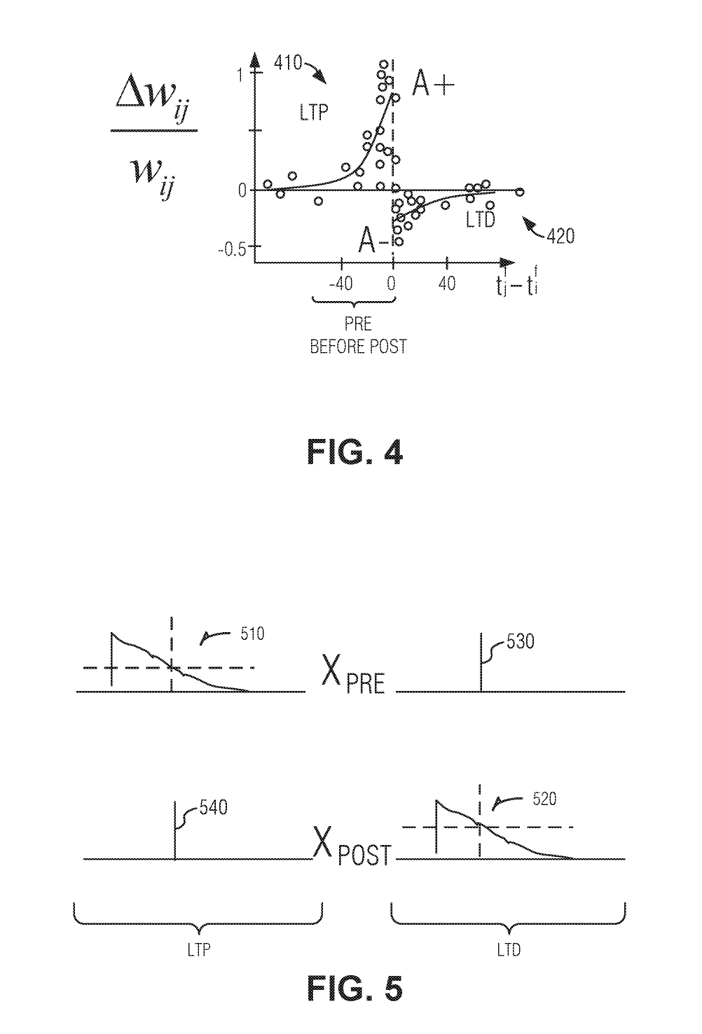

FIG. 4 illustrates an example STDP results in synapse weighting, according to an embodiment. The y axis indicates a synaptic weight and the x axis indicates time. The vertical dashed line indicates a time in which a post spike (e.g., a spike produced by the neuron to which the synapse belongs) occurred. As shown, the effect of changes of a synaptic weight (Δwᵢⱼ) are determined relative to the synaptic weight (wᵢⱼ). Thus, the weights to the left of the vertical line evidence long term potentiation (LTP) 410 and those to the right evidence long term depression (LTD) 420.

Evident in the plot of FIG. 4 is the relationship between a time of an input, or pre spike, and the time of the post spike. Although an inverse exponential relationship is here illustrated, generally, the closer the pre spike is to the post spike, the greater the synapse is strengthened. Similarly, the closer a spike following the post spike is, the greater the weakening effect to the responsible synapse's weight.

FIG. 5 illustrates an example of values from unsupervised STDP learning, according to an embodiment. To continue the discussion of FIG. 4, FIG. 5 illustrates a specific selection of weight adjustments based on timing of pre spikes and post spikes. Specifically, for LTP, a pre spike trace 510 defines a decay for the pre spike once it is received. When post spike 540 occurs, the time of the post spike is used to calculate the weight adjustment of the pre spike synapse via the pre spike decay, here illustrated with the cross-hairs. Thus, in this example, the synapse's weight will be modified by the value indicated at the cross hairs.

In a similar manner, for LTD, when the post spike occurs, a post spike decay 520 defines weight depression as a function of time for a pre spike 530 following the post spike 540. Again, the weight for the synapse responsible for the pre spike 530 is adjusted by the value under the crosshairs defined by the post spike decay. In this case, however, the synapse is weakened.

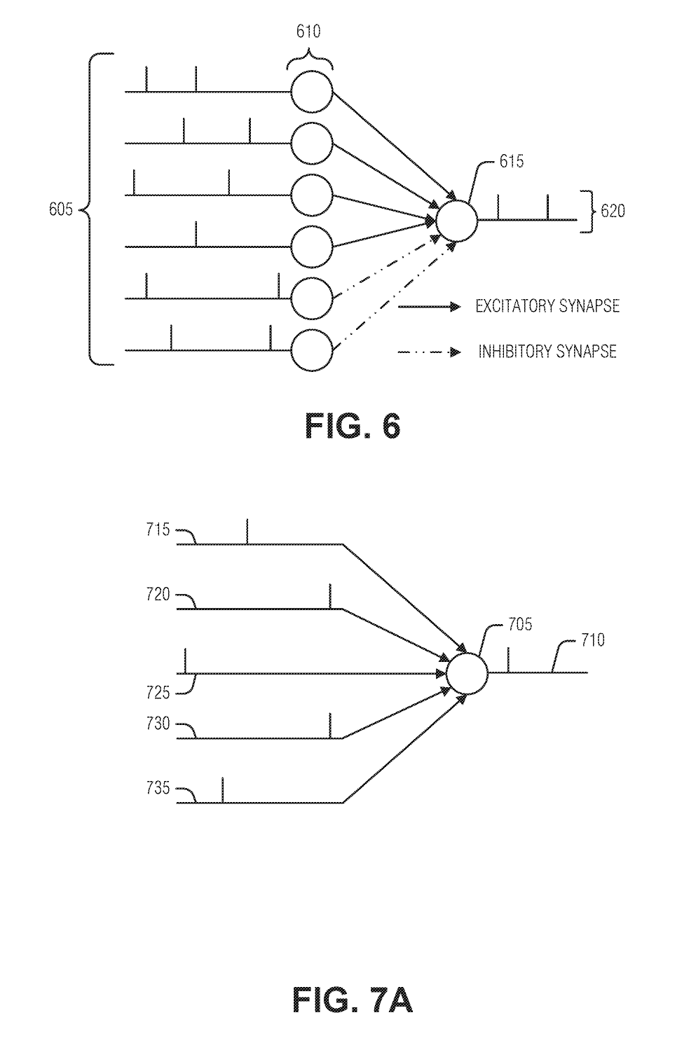

FIG. 6 illustrates an example of SNN learning a pattern via STDP, according to an embodiment. The SNN of FIG. 6 includes a number of spike trains 605 feeding into a plurality of input neurons 610. The input neurons 610 are then connected with an output neuron 615 that produces the spike train 620. The inhibitory synapses provide spikes that inhibit the spiking of the output neuron 615.

As noted above, when a network such as that illustrated implements STDP, the network will converge on a pattern. This works because the reoccurrence of the pattern will provide a consistent group of participant synapses in the spiking of the output neuron 615. Experiments have also shown that the pattern is recognized with a very minimal introduction, the spike train 620 providing spikes within a very short time of pattern presentation when the network is used for inference (e.g., pattern detection) purposes. Such a network, provided with 2000 input neurons 610 and one output neuron 615, was presented with a pattern embedded in 1000 inputs (e.g., to specific input neurons 610) with duration of 50 milliseconds at random times and with jitter. The remaining input neurons 610 received Poisson noise. The total presentation was for 450 seconds.

After approximately 70 presentations (or about 13 seconds) the output neuron 615 stopped discharging outside the pattern (e.g., no false alarms in the spike train 620) while only discharging within pattern presence (e.g., having a high hit rate). After convergence, the output neuron 615 only discharged once for any given presentation of the pattern at beginning of the pattern presentation, providing a very low latency to the pattern detection. This experiment demonstrated that STDP helps detect a repeating pattern embedded within dense distractor spike trains (e.g., noise), providing coincidence detection that is robust to jitter, to missing spikes, and to noise.

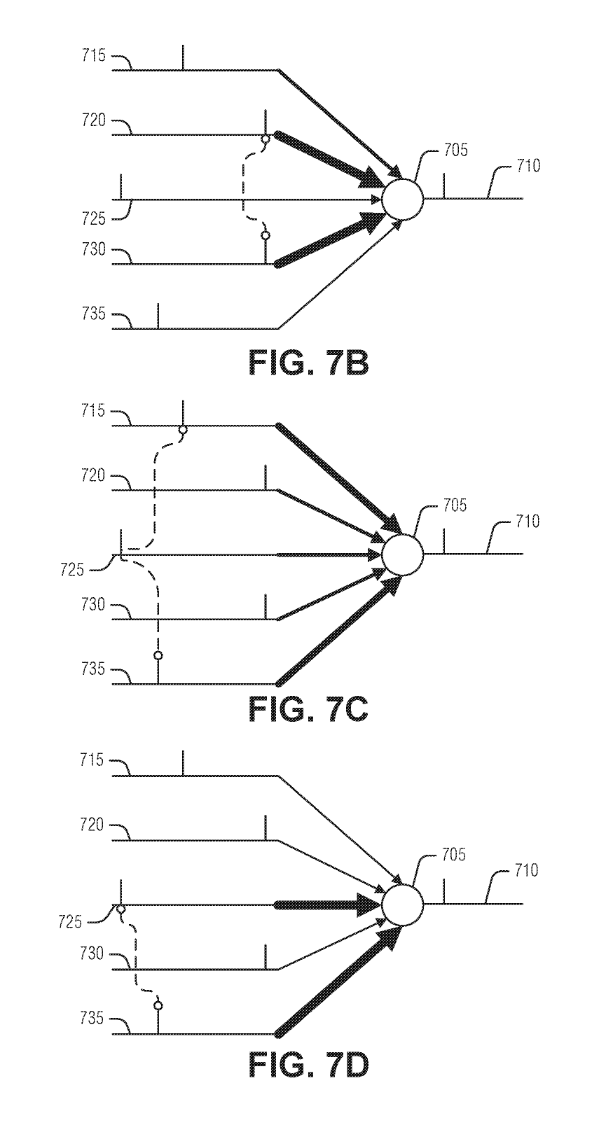

FIGS. 7A-7D illustrate an example of synapse weight progression during SNN learning via STDP, according to an embodiment. These figures walk through a use case of the STDP learning discussed above.

FIG. 7A illustrates an initial state where synapses (the arrows emanating from spike trains 715-735) are initially weak (the strength of the synapses is represented by their respective thicknesses). Each of spike trains 715-735 have a single spike and the neuron 705 includes a single spike in its spike train 710. Here, for the purposes of the example, it is assumed that the neuron 705 requires two strong spikes to generate the post synaptic spike in its spike train 710.

FIG. 7B illustrates that, after some repeated presentation of the pattern (as well as any accompanying noise), STDP causes the synapse receiving spike train 715 to be somewhat strengthened and the synapses corresponding to spike trains 720 and 730 to become greatly strengthened (indicated by the dashed connector between spikes). During this phase, STDP has quickly identified these synapses as large contributors to the post synaptic spike of the neuron 705. However, these are initial impressions of STDP when presented with the pattern.

FIG. 7C illustrates that, after additional presentations, the collection of spike trains contributing to the post synaptic spike has changed. Specifically, the strength of the synapses from FIG. 7B are weakened (due to inconsistent presence during post synaptic spiking) and synapses corresponding to spike trains 715, 725, and 735 are strengthened (illustrated by the dashed connector between spikes).

FIG. 7D illustrates a final weighting of synapses after the training presentations are concluded. Here, the network converged to give the greatest strength to the synapses corresponding to spike trains 725 and 735 (illustrated by the dashed connector between spikes) while weakening the previously strong synapses. This progression may occur because the earlier synapses, while part of the pattern, may have presented later in time in the pattern while the synapses chosen at the end to be the strongest represent the earliest consistent action evidencing the pattern. While this behavior of STDP systems leads to low latency in ascertaining the presence of a pattern, it may have some difficulty in multi-part patterns, where multi patterns, or multiple patterns with similar beginning sequences, are present.

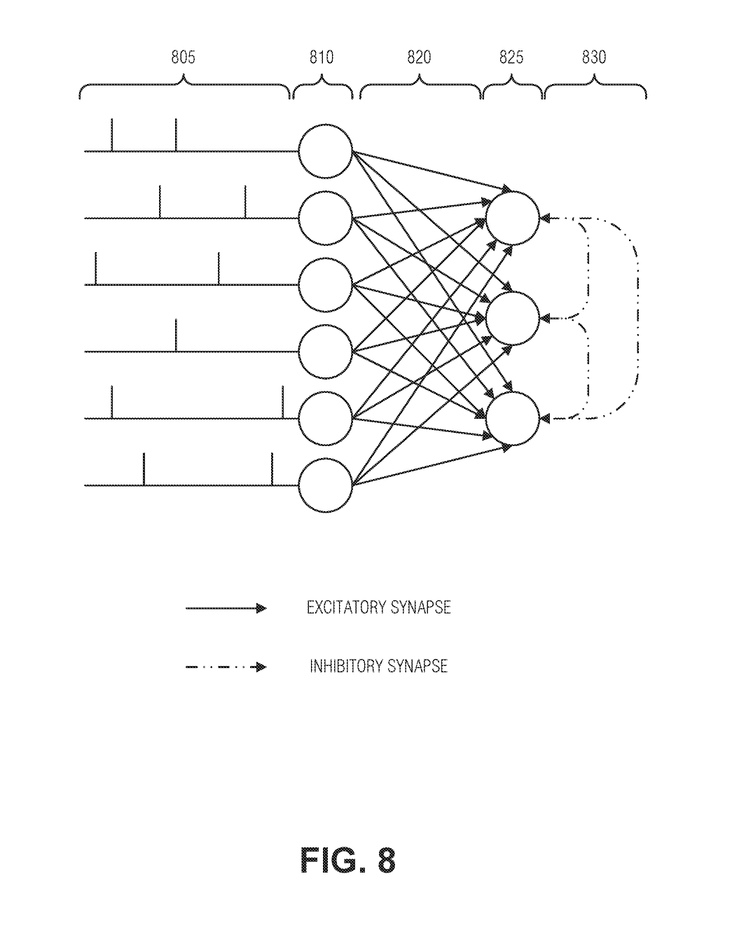

FIG. 8 illustrates an example of a SNN to implement multi-part pattern, or multiple pattern, detection in an SNN, according to an embodiment. The SNN includes input spike trains 805 and input neurons 810, much like those described above with respect to FIG. 6. Here, however, the SNN includes an output neuron 825 for each part of the multi-part pattern, or for each pattern, the output neuron 825 spiking (not shown) when a pattern is detected. Thus, as illustrated, this SNN may identify three parts of the pattern. The output neurons 825 are connected by the synapses 820 to the input neurons 810 and operate as in an SNN (e.g., they are excitatory performing additive STDP).

Unlike the SNNs described above, however, the output neurons 825 are also connected to each other via recurrent inhibitory synapses 830. By the operations of these inhibitory synapses 830, when an output neuron 825 spikes, it will suppress the spiking behavior of the other output neurons 825. Thus, whichever output neuron converges most quickly upon a given pattern will claim responsibility for that pattern (e.g., winner takes all) as the other output neurons 825, without spiking, will fail to reinforce the synapses 820 contributing to the claimed pattern as illustrated above in FIGS. 7A-7D.

The inhibitory effect may include a prohibition on spiking. Thus, upon receipt of the inhibitory spike, the recipient node simply does not spike even if the inputs are sufficient to cause a spike. In an example, the inhibitory effect is a reverse application of the weight applied to a standard synapse 820. For example, the inhibitory synapse 830 includes a weight, but rather than adding to the effect of the traditional synapse 820, it subtracts. This technique may address some race conditions between two output neurons otherwise converging on the same part of the pattern at the same time.

The above technique will identify multiple unrelated patterns because each output neuron 825 converges on different ones of those patterns. If two output neurons 825 start converging on the same pattern, it is likely (assuming random initialization of synapse weights) that one will converge earlier and thus suppress the ability of the second to converge on the same pattern. Being unable to converge on its initial pattern, this second output neuron 825 will proceed to strengthen synapses 820 for a second pattern. This principle operates the same for differences in time or space (e.g., input neurons 810). Thus, the multi-part pattern may be simultaneous unrelated patterns, patterns of action that are related but separated in time (e.g., the thumb gesture example above) or related patterns separated in space. Each of these examples is a multi-part pattern as used herein.

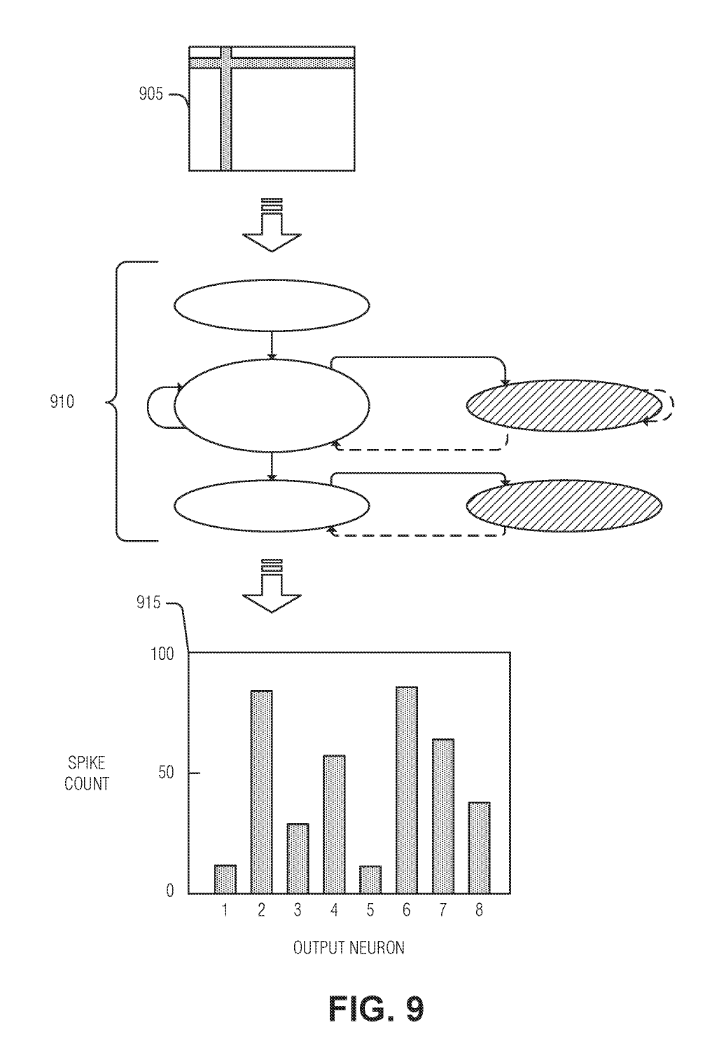

FIG. 9 illustrates encoding an image into a feature-set using an SNN 910, according to an embodiment. As noted above, the SNN 910 may be used as the feature extraction device because the SNN 910 performs efficiently, in terms of time, power, and accuracy, even with small training data sets. The example illustrated here maps pixels of an input image 905 to SNN inputs where the pixel values are converted into spike sequences. Thus, a 400×400 image is mapped to 160,000 neurons of the SNN 910 assuming a single color channel. The number of input neurons used may increase linearly with the number of color channels (e.g., 320,000 neurons for two colors. 640,000 for four colors, etc.).

The spike sequences may be based on a pixel luminance. Thus, for example, the pixel is black, the neuron is assigned a mean firing rate of 90 Hz. In case the pixel is white, the neuron may be assigned a mean firing rate of 10 Hz. The mean firing rate for luminance values between black or white may have a linear distribution, or some other distribution, such as Gaussian.

In the feature extraction phase, the SNN 910 uses STDP to training itself on the training set, eventually producing stable output spiking patterns 915. In an example, samples from the training set are presented in random order for a duration with exponential distribution. It is the feature set 915 that is passed to the SVM for training.

SVMs are based on structural risk minimization. Between feature clusters in a space, a hyperplane traces a maximum distance between features of each class. To perform classification with an SVM, the following is used

$$f ( x ) = sgn ( {\sum }_{i = 1}^{{N}_{S}} {y}_{i} {α}_{i} K ( x , {s}_{i} ) + b )$$

where:
N_{S} is the number of support vectors (SVs)
yᵢ are the class labels. In the case of two classes, they may be assigned the values of 1 and −1 respectively.
αᵢ are the SV weights.
K(x, sᵢ) is the kernel function. Here, the SVM kernel method is used to convert original vector manipulations into scalar operations by transforming feature coordinates to straighten the hyperplane. Kernels may be selected for a variety of designs reasons. Examples of kernels may include polynomial, radial, or sigmoid kernels.
x is the vector corresponding to the example being classified.
sᵢ is a SV from the SVs S. SVs are a subset of training data (e.g., examples used during training) that are mostly close to the decision hyperplane.
b is a parameter used to adjust classifications.

Reduced set SVM creation involves calculating vectors, which are not necessarily support vectors, that may be substituted for the original decision hyper plane. The reduced set vectors have the following properties: they are interchangeable with the original SVs the decision function noted above; and they are not training examples and therefore they are not SVs. The decision function using the reduced set vectors may be expressed as:

$${f}_{ResSet} ( x ) = {\sum }_{i = 1}^{{N}_{S}} {y}_{i} {α}_{i}^{RedSet} K ( x , {z}_{i} ) + b$$

where:
zᵢ are the reduced set vectors.
αᵢ^{RedSet} are coefficients for the reduced set vectors.

In an example, for second order Homogenous Kernels, BRSM may be used to calculate the reduced set:

K(xᵢ,xⱼ)=(αxᵢ,xⱼ)²

This operates by calculating a S_{μv}, matrix:

$${S}_{μ v} ≡ {\sum }_{i = 1}^{{N}_{S}} {α}_{i} {y}_{i} {s}_{i μ} {s}_{iv}$$

where:
S_{iμ} is the matrix of support vectors.
i is the index of a support vector.
μ is the index of the attributes in the feature vectors.

Next, eigenvalue decomposition of S_{μv} is performed. Assume that S_{μv} has N_{z} eigenvalues. Generally, N_{z} will be equal to the feature vector size. The eigenvectors zᵢ of S_{μv} will become the reduced set vectors.

As noted above, reduced set vectors may be exchanged for the original SVs and generate exactly the same hyperplane as the original SVs.

If λᵢ are the eigenvalues, then the weighting factors for the reduced set technique may be calculated as:

$${α}_{i}^{RedSet} = \frac{{λ}_{i}}{\vert \vert {Z}_{i} {\vert \vert}^{2}}$$

If the number of new reduced set vectors is equal to the dimension of feature vector, then the reduced set vectors exactly emulate the original classification hyperplane. This feature enables reduction of the number of SVs to feature vector size, increasing classification speed with zero degradation of the classification performance.

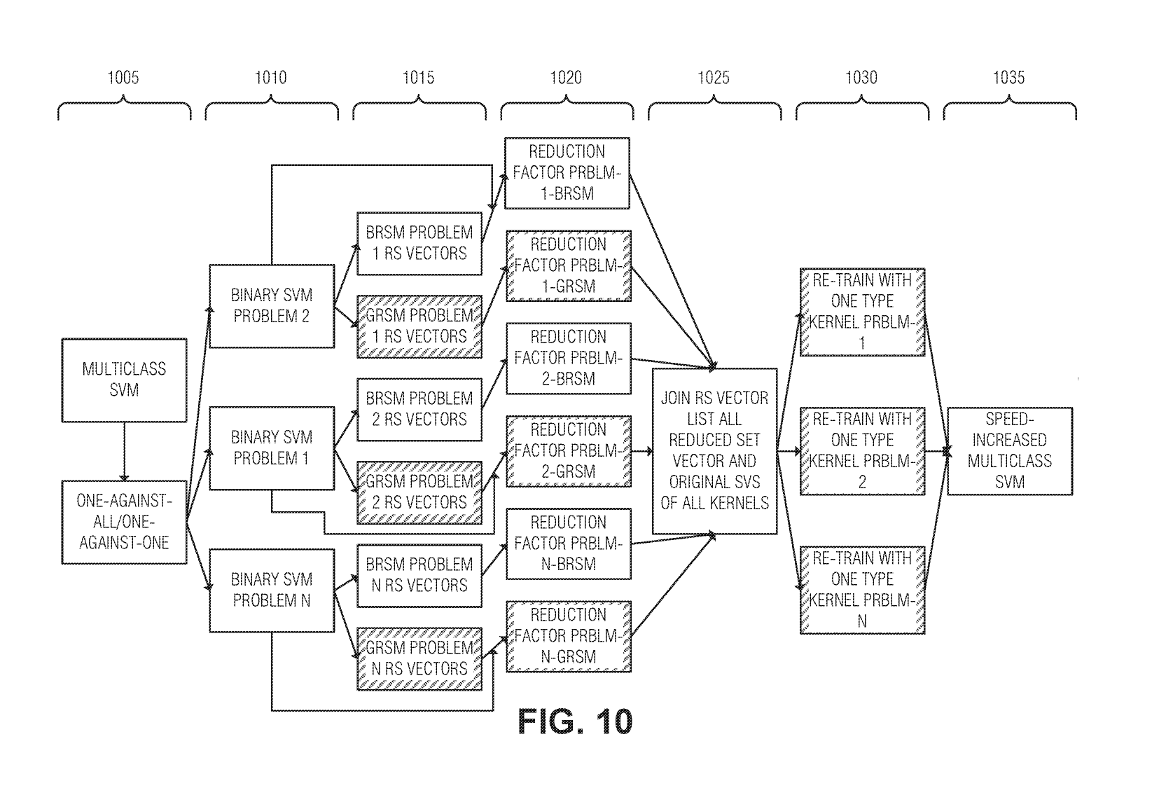

FIG. 10 illustrates a pipeline to create a reduced set SVM, according to an embodiment. The reduced set vector technique described above operates on a binary classification model. The pipeline illustrated here extends the reduced set method to multiclass models.

Generally, multiclass SVMs are created by cascading binary solutions. As each binary solution is combined, a variety of techniques may be used, such as one-against-all or one-against-one. The pipeline starts with a number of binary solutions being integrated into a multiclass SVM using a binary class integration technique (stage 1005) to produce binary solutions (stage 1010). Different techniques, such as BRSM, GRSM-Gaussian Reduced Set Method, etc., are applied (stage 1015) to produce reduced set vectors (stage 1020). A combined joint list of vectors is created and all reduced set vectors are added to the list (stage 1025). In an example, the original SV for all binary problems are also added to this list.

Once the combined join list is populated, all binary problems may be retrained using the joint list and one and only one of the original kernels (stage 1030) to create the optimized (e.g., speed-increased) multiclass reduced set SVM (stage 1035). For example, if BRSM and GRSM where used in stage 1015, then either one, but not both, are used in stage 1030, to produce the SVM of stage 1035.

As noted above, reducing the number of vectors used in classifications increases the SVM performance. A reduction factor (e.g., performance metric) may be defined to allow aggressive pruning of the vectors while maintaining a minimum classification accuracy (e.g., performance). For example, where BRSM was used to create the reduced set SVM, the number of SVs may be further reduced by keeping only those with a high weighting factor. In case of the GRSM, SVs may be eliminated that have smaller αᵢ^{RedSet} values because they contribute less to the final testing function.

In an example, reduction is iterative, and is stopped when a predefined threshold of performance is passed. In an example, different reductions may be applied to the final list for the different binary problems. The reduction parameter may be same for all binary classes or may give more importance to some classes over others. The reduction factor may be selected to create a reduced set SVM that meets designed time or classification performance.

In an example, instead of classification time, detection precision may be modified by the reduction factor by reducing the number of vectors and observing how the detection vs. false positive rate degrades. This may be performed for each individual binary problem separately or by observing the final multiclass classification performance. In an example, a reduction function may be selected to prioritize to the vector lists of one kernel over another. This may be useful when experiments reveal that a kernel gives better classification results than other kernels.

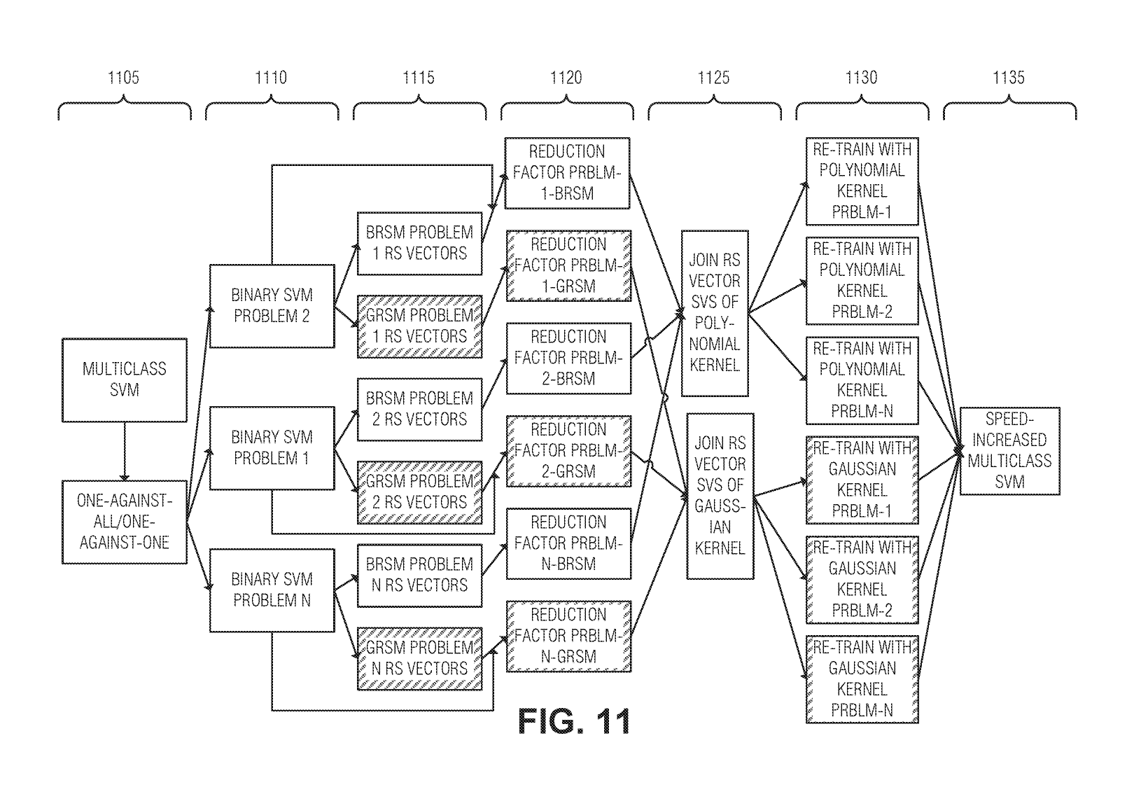

FIG. 11 illustrates a pipeline to create a reduced set SVM, according to an embodiment. The pipeline illustrated here operates similarly to that of FIG. 10. The binary problems (stage 1110) are extracted from the SVM (stage 1105), and reduced (stage 1115) to create the reduced set vectors (stage 1120). Here, however, multiple kernels, rather than just one kernel, are used. A joint list is thus created for each kernel in use (stage 1125) and populated with reduced set vectors created in stage 1115 by the same kernel. For example, where BRSM and GRSM are used, there are two joint lists. The respective joint lists are used by the corresponding kernels in retraining (stage 1130) to produce the optimized SVM (stage 1135). Because the different Kernels are combined in a different way, there may be additional reduction function operations available to further reduce the decision vectors.

The multiclass reduced set SVM techniques described above have yielded experimental results demonstrating their power. In the binary problem, when BRSM is used, it is possible to achieve reduce set vectors the size of vector feature attributes. For example, if the number of SVs in the model is 10,000, and the feature vector has 100 attributes, then it is possible to reduce the SVs to 100. Because the SVM classification time is linearly proportional to the number of SVs, this reduction results in a speed-up factor (e.g., an increase in classification speed)

$$\frac{10000}{100} = 100.$$

This increased performance is achieved without impacting classification accuracy. Additional examples include:
A two-class problem on 23,000 car examples

| | | NO CARS | |
|---|---|---|---|
| CLASS | CARS | CLASS | TOTAL |
| SUPPORT | 4000 | 6000 | 10000 |
| VECTORS | | | |
| REDUCED SET | 50 | 50 | 100 |
| VECTORS | | | |

| | |
|---|---|
| SPEED-UP | 100 |
| FACTOR | |

Experimentally, using BRSM on a three-class problem resulted in speed-up factors between ten and fifty times. For example:

A three-class problem on 20,000 car examples

| | | | NO CARS | |
|---|---|---|---|---|
| CLASS | CARS FRONT | CARS BACK | CLASS | TOTAL |
| SUPPORT | 4759 | 2755 | 2223 | 9738 |
| VECTORS | | | | |
| REDUCED SET | 256 | 256 | 256 | 768 |
| VECTORS | | | | |

| | |
|---|---|
| SPEED-UP | 12 |
| FACTOR | |

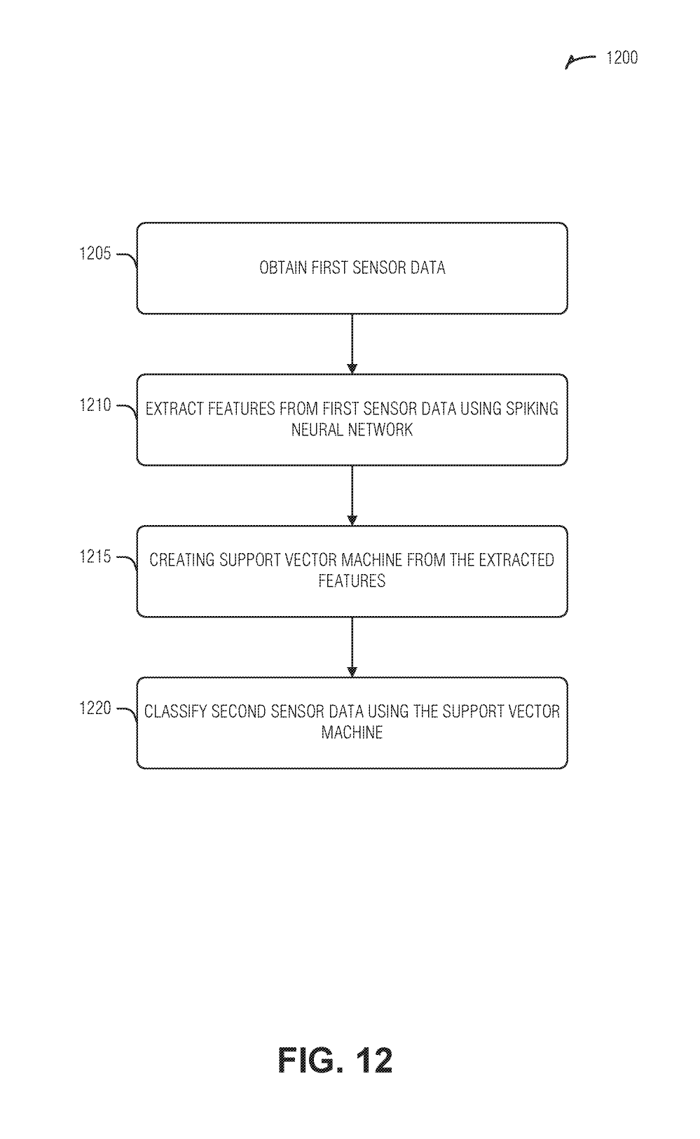

FIG. 12 illustrates a flow diagram of an example of a method 1200 for a hybrid classifier, according to an embodiment. The operations of the method 1200 are performed by computer hardware, such as that described herein (e.g., a neural core, processing circuitry, etc.).

At operation 1205, a first set of sensor data is obtained (e.g., retrieved or received). In an example, the first set of sensor data is encoded as a frequency of spikes. In an example, the sensor data is an image encoded in pixels with a luminance value. In an example, the frequency of spikes is inversely related to the luminance value. In an example, a luminance value equivalent to black has a frequency often hertz, and a luminance value equivalent to white has a frequency of ninety hertz.

At operation 1210, a feature set is extracted from the sensor data using a SNN. In an example, the feature set is a frequency of spikes from output neurons of the SNN. In an example, neurons in a pattern recognition layer of the SNN include inhibitory paths to all other neurons of the pattern recognition layer.

At operation 1215, an SVM is created for the sensor data using the feature set. In an example, the SVM is a reduced set vector SVM that uses eigenvectors, derived from support vectors, in place of the support vectors. In an example, the SVM is a multiclass SVM. In an example, creating the SVM includes creating SVM solutions for binary classifications of a set of possible classifications. Here, a binary classification separates input into one of two classes. In an example, at least one technique of one-against-one or one-against-all is used for the binary classifications.

In an example, creating the SVM includes reducing each SVM solution for the binary classes. In an example, reducing an SVM solution includes performing eigenvalue decomposition on support vectors for each SVM solution to find eigenvectors to replace the support vectors.

In an example, creating the SVM includes combining reduced set vectors for all SVM solutions for binary classifications into a single joint list. All binary SVM solutions may then be retrained using the joint list. In an example, original support vectors for each SVM solution for binary classifications are also included in the joint list. In an example, one of several kernels is used in the retraining.

In an example, combining the reduced set vectors includes pruning vectors. In an example, pruning vectors includes at least one of reducing a vector size or eliminating a vector with a low weighting factor.

In an example, vector pruning iterates until a performance metric is reached. In an example, the performance metric is ratio of detection to false positive. In an example, the performance metric is a time-to-classification measure.

At operation 1220, a second set of sensor data is classified using the SVM.

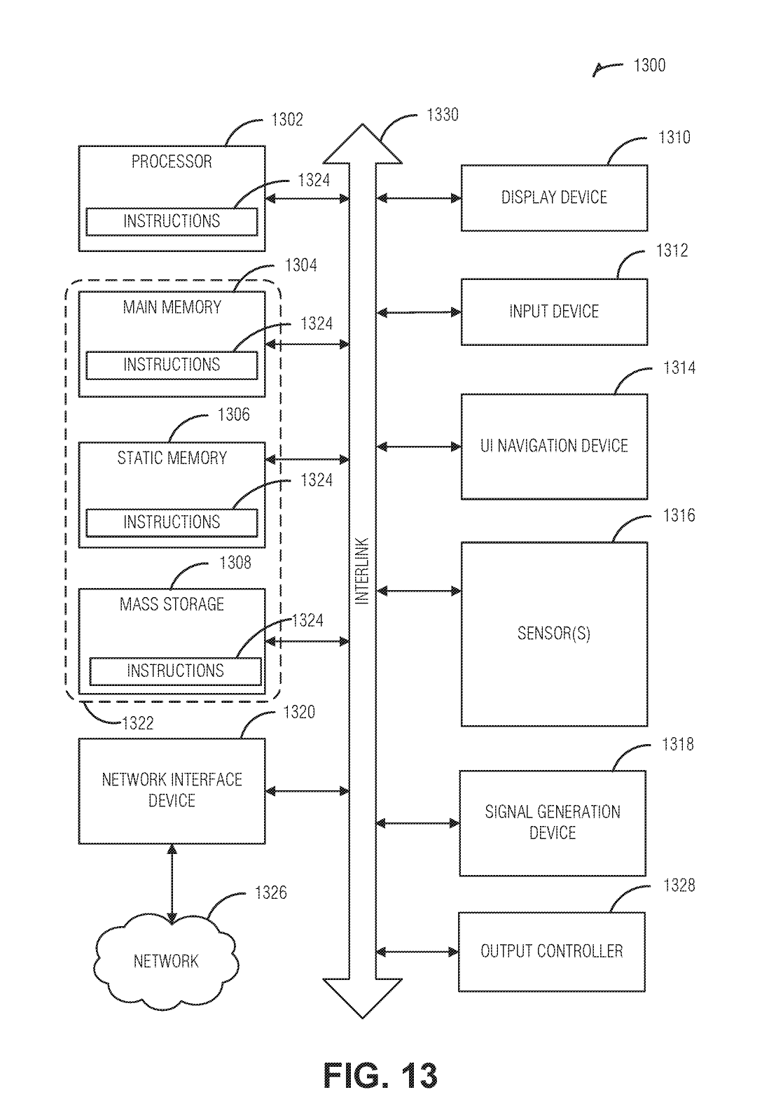

FIG. 13 illustrates a block diagram of an example machine 1300 upon which any one or more of the techniques (e.g., methodologies) discussed herein may perform. Examples, as described herein, may include, or may operate by, logic or a number of components, or mechanisms in the machine 1300. Circuitry (e.g., processing circuitry) is a collection of circuits implemented in tangible entities of the machine 1300 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1300 follow.

In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1300 may include a hardware processor 1302 (e.g., a central processing unit (CPU), a graphics processing unit (GPU), a hardware processor core, or any combination thereof), a main memory 1304, a static memory (e.g., memory or storage for firmware, microcode, a basic-input-output (BIOS), unified extensible firmware interface (UEFI), etc.) 1306, and mass storage 1308 (e.g., hard drive, tape drive, flash storage, or other block devices) some or all of which may communicate with each other via an interlink (e.g., bus) 1330. The machine 1300 may further include a display unit 1310, an alphanumeric input device 1312 (e.g., a keyboard), and a user interface (UI) navigation device 1314 (e.g., a mouse). In an example, the display unit 1310, input device 1312 and UI navigation device 1314 may be a touch screen display. The machine 1300 may additionally include a storage device (e.g., drive unit) 1308, a signal generation device 1318 (e.g., a speaker), a network interface device 1320, and one or more sensors 1316, such as a global positioning system (GPS) sensor, compass, accelerometer, or other sensor. The machine 1300 may include an output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1302, the main memory 1304, the static memory 1306, or the mass storage 1308 may be, or include, a machine readable medium 1322 on which is stored one or more sets of data structures or instructions 1324 (e.g., software) embodying or utilized by any one or more of the techniques or functions described herein. The instructions 1324 may also reside, completely or at least partially, within any of registers of the processor 1302, the main memory 1304, the static memory 1306, or the mass storage 1308 during execution thereof by the machine 1300. In an example, one or any combination of the hardware processor 1302, the main memory 1304, the static memory 1306, or the mass storage 1308 may constitute the machine readable media 1322. While the machine readable medium 1322 is illustrated as a single medium, the term “machine readable medium” may include a single medium or multiple media (e.g., a centralized or distributed database, and/or associated caches and servers) configured to store the one or more instructions 1324.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may be further transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1300, and includes digital or analog communications signals or other intangible medium to facilitate communication of such software. A transmission medium is a machine readable medium.

### Additional Notes & Examples

Example 1 is a system for a hybrid classifier, the system comprising: an interface to obtain a first set of sensor data: a memory to store instructions; and processing circuitry configured by the instructions to: extract a feature set from the sensor data using a spiking neural network (SNN); create a support vector machine (SVM) for the sensor data using the feature set; and classify a second set of sensor data using the SVM.

In Example 2, the subject matter of Example 1 includes, wherein the first set of sensor data is encoded as a frequency of spikes.

In Example 3, the subject matter of Example 2 includes, wherein the sensor data is an image encoded in pixels with a luminance value.

In Example 4, the subject matter of Example 3 includes, wherein the frequency of spikes is inversely related to the luminance value.

In Example 5, the subject matter of Example 4 includes, wherein a luminance value equivalent to black has a frequency of ten hertz, and a luminance value equivalent to white has a frequency of ninety hertz.

In Example 6, the subject matter of Examples 2-5 includes, wherein the feature set is a frequency of spikes from output neurons of the SNN.

In Example 7, the subject matter of Examples 1-6 includes, wherein neurons in a pattern recognition layer of the SNN include inhibitory paths to all other neurons of the pattern recognition layer.

In Example 8, the subject matter of Examples 1-7 includes, wherein the SVM is a reduced set vector SVM that uses eigenvectors, derived from support vectors, in place of the support vectors.

In Example 9, the subject matter of Example 8 includes, wherein the SVM is a multiclass SVM.

In Example 10, the subject matter of Example 9 includes, wherein, to create the SVM, the processing circuitry creates SVM solutions for binary classifications of a set of possible classifications, a binary classification separating input into one of two classes.

In Example 11, the subject matter of Example 10 includes, wherein at least one technique of one-against-one or one-against-all is used for the binary classifications.

In Example 12, the subject matter of Examples 10-11 includes, wherein, to create the SVM, the processing circuitry reduces each SVM solution for the binary classes.

In Example 13, the subject matter of Example 12 includes, wherein, to reduce an SVM solution, the processing circuitry performs eigenvalue decomposition on support vectors for each SVM solution to find eigenvectors to replace the support vectors.

In Example 14, the subject matter of Examples 12-13 includes, wherein, to create the SVM, the processing circuitry: combines reduced set vectors for all SVM solutions for binary classifications into a single joint list; and retrains all binary SVM solutions using the joint list.

In Example 15, the subject matter of Example 14 includes, wherein original support vectors for each SVM solution for binary classifications are also included in the joint list.

In Example 16, the subject matter of Examples 14-15 includes, wherein one of several kernels is used in the retraining.

In Example 17, the subject matter of Examples 14-16 includes, wherein, to combine the reduced set vectors, the processing circuitry prunes vectors.

In Example 18, the subject matter of Example 17 includes, wherein, to prune vectors, the processing circuitry at least one of reduces a vector size or eliminates a vector with a low weighting factor.

In Example 19, the subject matter of Examples 17-18 includes, wherein the processing circuitry performs vector pruning iteratively until a performance metric is reached.

In Example 20, the subject matter of Example 19 includes, wherein the performance metric is ratio of detection to false positive.

In Example 21, the subject matter of Examples 19-20 includes, wherein the performance metric is a time-to-classification measure.

Example 22 is a method for a hybrid classifier, the method comprising: obtaining a first set of sensor data; extracting a feature set from the sensor data using a spiking neural network (SNN); creating a support vector machine (SVM) for the sensor data using the feature set; and classifying a second set of sensor data using the SVM.

In Example 23, the subject matter of Example 22 includes, wherein the first set of sensor data is encoded as a frequency of spikes.

In Example 24, the subject matter of Example 23 includes, wherein the sensor data is an image encoded in pixels with a luminance value.

In Example 25, the subject matter of Example 24 includes, wherein the frequency of spikes is inversely related to the luminance value.

In Example 26, the subject matter of Example 25 includes, wherein a luminance value equivalent to black has a frequency of ten hertz, and a luminance value equivalent to white has a frequency of ninety hertz.

In Example 27, the subject matter of Examples 23-26 includes, wherein the feature set is a frequency of spikes from output neurons of the SNN.

In Example 28, the subject matter of Examples 22-27 includes, wherein neurons in a pattern recognition layer of the SNN include inhibitory paths to all other neurons of the pattern recognition layer.

In Example 29, the subject matter of Examples 22-28 includes, wherein the SVM is a reduced set vector SVM that uses eigenvectors, derived from support vectors, in place of the support vectors.

In Example 30, the subject matter of Example 29 includes, wherein the SVM is a multiclass SVM.

In Example 31, the subject matter of Example 30 includes, wherein creating the SVM includes creating SVM solutions for binary classifications of a set of possible classifications, a binary classification separating input into one of two classes.

In Example 32, the subject matter of Example 31 includes, wherein at least one technique of one-against-one or one-against-all is used for the binary classifications.

In Example 33, the subject matter of Examples 31-32 includes, wherein creating the SVM includes reducing each SVM solution for the binary classes.

In Example 34, the subject matter of Example 33 includes, wherein reducing an SVM solution includes performing eigenvalue decomposition on support vectors for each SVM solution to find eigenvectors to replace the support vectors.

In Example 35, the subject matter of Examples 33-34 includes, wherein creating the SVM includes: combining reduced set vectors for all SVM solutions for binary classifications into a single joint list; and retraining all binary SVM solutions using the joint list.

In Example 36, the subject matter of Example 35 includes, wherein original support vectors for each SVM solution for binary classifications are also included in the joint list.

In Example 37, the subject matter of Examples 35-36 includes, wherein one of several kernels is used in the retraining.

In Example 38, the subject matter of Examples 35-37 includes, wherein combining the reduced set vectors includes pruning vectors.

In Example 39, the subject matter of Example 38 includes, wherein pruning vectors includes at least one of reducing a vector size or eliminating a vector with a low weighting factor.

In Example 40, the subject matter of Examples 38-39 includes, wherein vector pruning iterates until a performance metric is reached.

In Example 41, the subject matter of Example 40 includes, wherein the performance metric is ratio of detection to false positive.

In Example 42, the subject matter of Examples 40-41 includes, wherein the performance metric is a time-to-classification measure.

Example 43 is at least one machine readable medium including instructions that, when executed by a machine, cause the machine to perform any method of Examples 22-42.

Example 44 is a system comprising means to perform any method of Examples 22-42.

Example 45 is at least one computer readable medium including instructions for a hybrid classifier, the instructions, when executed by a machine, cause the machine to perform operations comprising: obtaining a first set of sensor data; extracting a feature set from the sensor data using a spiking neural network (SNN); creating a support vector machine (SVM) for the sensor data using the feature set; and classifying a second set of sensor data using the SVM.

In Example 46, the subject matter of Example 45 includes, wherein the first set of sensor data is encoded as a frequency of spikes.

In Example 47, the subject matter of Example 46 includes, wherein the sensor data is an image encoded in pixels with a luminance value.

In Example 48, the subject matter of Example 47 includes, wherein the frequency of spikes is inversely related to the luminance value.

In Example 49, the subject matter of Example 48 includes, wherein a luminance value equivalent to black has a frequency of ten hertz, and a luminance value equivalent to white has a frequency of ninety hertz.

In Example 50, the subject matter of Examples 46-49 includes, wherein the feature set is a frequency of spikes from output neurons of the SNN.

In Example 51, the subject matter of Examples 45-50 includes, wherein neurons in a pattern recognition layer of the SNN include inhibitory paths to all other neurons of the pattern recognition layer.

In Example 52, the subject matter of Examples 45-51 includes, wherein the SVM is a reduced set vector SVM that uses eigenvectors, derived from support vectors, in place of the support vectors.

In Example 53, the subject matter of Example 52 includes, wherein the SVM is a multiclass SVM.

In Example 54, the subject matter of Example 53 includes, wherein creating the SVM includes creating SVM solutions for binary classifications of a set of possible classifications, a binary classification separating input into one of two classes.

In Example 55, the subject matter of Example 54 includes, wherein at least one technique of one-against-one or one-against-all is used for the binary classifications.

In Example 56, the subject matter of Examples 54-55 includes, wherein creating the SVM includes reducing each SVM solution for the binary classes.

In Example 57, the subject matter of Example 56 includes, wherein reducing an SVM solution includes performing eigenvalue decomposition on support vectors for each SVM solution to find eigenvectors to replace the support vectors.

In Example 58, the subject matter of Examples 56-57 includes, wherein creating the SVM includes: combining reduced set vectors for all SVM solutions for binary classifications into a single joint list; and retraining all binary SVM solutions using the joint list.

In Example 59, the subject matter of Example 58 includes, wherein original support vectors for each SVM solution for binary classifications are also included in the joint list.

In Example 60, the subject matter of Examples 58-59 includes, wherein one of several kernels is used in the retraining.

In Example 61, the subject matter of Examples 58-60 includes, wherein combining the reduced set vectors includes pruning vectors.

In Example 62, the subject matter of Example 61 includes, wherein pruning vectors includes at least one of reducing a vector size or eliminating a vector with a low weighting factor.

In Example 63, the subject matter of Examples 61-62 includes, wherein vector pruning iterates until a performance metric is reached.

In Example 64, the subject matter of Example 63 includes, wherein the performance metric is ratio of detection to false positive.

In Example 65, the subject matter of Examples 63-64 includes, wherein the performance metric is a time-to-classification measure.

Example 66 is a system for a hybrid classifier, the system comprising: means for obtaining a first set of sensor data; means for extracting a feature set from the sensor data using a spiking neural network (SNN); means for creating a support vector machine (SVM) for the sensor data using the feature set; and means for classifying a second set of sensor data using the SVM.

In Example 67, the subject matter of Example 66 includes, wherein the first set of sensor data is encoded as a frequency of spikes.

In Example 68, the subject matter of Example 67 includes, wherein the sensor data is an image encoded in pixels with a luminance value.

In Example 69, the subject matter of Example 68 includes, wherein the frequency of spikes is inversely related to the luminance value.

In Example 70, the subject matter of Example 69 includes, wherein a luminance value equivalent to black has a frequency of ten hertz, and a luminance value equivalent to white has a frequency of ninety hertz.

In Example 71, the subject matter of Examples 67-70 includes, wherein the feature set is a frequency of spikes from output neurons of the SNN.

In Example 72, the subject matter of Examples 66-71 includes, wherein neurons in a pattern recognition layer of the SNN include inhibitory paths to all other neurons of the pattern recognition layer.

In Example 73, the subject matter of Examples 66-72 includes, wherein the SVM is a reduced set vector SVM that uses eigenvectors, derived from support vectors, in place of the support vectors.

In Example 74, the subject matter of Example 73 includes, wherein the SVM is a multiclass SVM.

In Example 75, the subject matter of Example 74 includes, wherein the means for creating the SVM include means for creating SVM solutions for binary classifications of a set of possible classifications, a binary classification separating input into one of two classes.

In Example 76, the subject matter of Example 75 includes, wherein at least one technique of one-against-one or one-against-all is used for the binary classifications.

In Example 77, the subject matter of Examples 75-76 includes, wherein the means for creating the SVM include means for reducing each SVM solution for the binary classes.

In Example 78, the subject matter of Example 77 includes, wherein the means for reducing an SVM solution include means for performing eigenvalue decomposition on support vectors for each SVM solution to find eigenvectors to replace the support vectors.

In Example 79, the subject matter of Examples 77-78 includes, wherein the means for creating the SVM include: means for combining reduced set vectors for all SVM solutions for binary classifications into a single joint list; and means for retraining all binary SVM solutions using the joint list.

In Example 80, the subject matter of Example 79 includes, wherein original support vectors for each SVM solution for binary classifications are also included in the joint list.

In Example 81, the subject matter of Examples 79-80 includes, wherein one of several kernels is used in the retraining.

In Example 82, the subject matter of Examples 79-81 includes, wherein the means for combining the reduced set vectors include means for pruning vectors.

In Example 83, the subject matter of Example 82 includes, wherein the means for pruning vectors include means for at least one of reducing a vector size or eliminating a vector with a low weighting factor.

In Example 84, the subject matter of Examples 82-83 includes, wherein vector pruning iterates until a performance metric is reached.

In Example 85, the subject matter of Example 84 includes, wherein the performance metric is ratio of detection to false positive.

In Example 86, the subject matter of Examples 84-85 includes, wherein the performance metric is a time-to-classification measure.

Example 87 is at least one machine-readable medium including instructions that, when executed by processing circuitry, cause the processing circuitry to perform operations to implement of any of Examples 1-86.

Example 88 is an apparatus comprising means to implement of any of Examples 1-86.

Example 89 is a system to implement of any of Examples 1-86.

Example 90 is a method to implement of any of Examples 1-86.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for a hybrid spiking neural network and support vector machine classifier, the system comprising:
an interface to obtain a first set of sensor data;
a memory to store executable computer program instructions; and
processing circuitry configured by the computer program instructions to:
extract one or more feature sets from the sensor data using a spiking neural network (SNN);
create a support vector machine (SVM) for the sensor data using the feature sets; and
classify a second set of sensor data using the SVM.

2. The system of claim 1, wherein the first set of sensor data is encoded as a frequency of spikes.

3. The system of claim 1, wherein the SVM is a reduced set vector SVM that uses eigenvectors, derived from support vectors, in place of the support vectors.

4. The system of claim 3, wherein the SVM is a multiclass SVM.

5. The system of claim 4, wherein, to create the SVM, the processing circuitry creates SVM solutions for binary classifications of a set of possible classifications, a binary classification separating input into one of two classes.

6. The system of claim 5, wherein, to create the SVM, the processing circuitry:
combines reduced set vectors for all SVM solutions for binary classifications into a single joint list by pruning a plurality of selected vectors; and
retrains all binary SVM solutions using the joint list.

7. The system of claim 6, wherein original support vectors for each SVM solution for binary classifications are also included in the joint list.

8. The system of claim 6, wherein one of several kernels is used in the retraining.

9. A method for a hybrid spiking neural network and support vector machine classifier, the method comprising:
obtaining a first set of sensor data;
extracting one or more feature sets from the sensor data using a spiking neural network (SNN);
creating a support vector machine (SVM) for the sensor data using the feature sets; and
classifying a second set of sensor data using the SVM.

10. The method of claim 9, wherein the first set of sensor data is encoded as a frequency of spikes.

11. The method of claim 9, wherein the SVM is a reduced set vector SVM that uses eigenvectors, derived from support vectors, in place of the support vectors.

12. The method of claim 11, wherein the SVM is a multiclass SVM.

13. The method of claim 12, wherein creating the SVM includes creating SVM solutions for binary classifications of a set of possible classifications, a binary classification separating input into one of two classes.

14. The method of claim 13, wherein creating the SVM includes:
combining reduced set vectors for all SVM solutions for binary classifications into a single joint list by pruning a plurality of selected vectors; and
retraining all binary SVM solutions using the joint list.

15. The system of claim 6, wherein original support vectors for each SVM solution for binary classifications are also included in the joint list.

16. The system of claim 6, wherein one of several kernels is used in the retraining.

17. At least one computer readable medium including executable computer program instructions for a hybrid spiking neural network and support vector machine classifier, the computer program instructions, when executed by a machine, cause the machine to perform operations comprising:
obtaining a first set of sensor data;
extracting one or more feature sets from the sensor data using a spiking neural network (SNN);
creating a support vector machine (SVM) for the sensor data using the feature sets; and
classifying a second set of sensor data using the SVM.

18. The computer readable medium of claim 17, wherein the first set of sensor data is encoded as a frequency of spikes.

19. The computer readable medium of claim 17, wherein the SVM is a reduced set vector SVM that uses eigenvectors, derived from support vectors, in place of the support vectors.

20. The computer readable medium of claim 19, wherein the SVM is a multiclass SVM.

21. The computer readable medium of claim 20, wherein creating the SVM includes creating SVM solutions for binary classifications of a set of possible classifications, a binary classification separating input into one of two classes.

22. The computer readable medium of claim 21, wherein creating the SVM includes:
combining reduced set vectors for all SVM solutions for binary classifications into a single joint list by pruning a plurality of selected vectors; and
retraining all binary SVM solutions using the joint list.

23. The computer readable medium of claim 22, wherein original support vectors for each SVM solution for binary classifications are also included in the joint list.

24. The computer readable medium of claim 22, wherein one of several kernels is used in the retraining.
